(19) United States
(12) Patent Application Publication
(10) Pub. No.: US 2001/0047665 A1
(43) Pub. Date: Dec. 6, 2001

(54) Application of deuterium oxide in producing silicon containing and metal containing materials

(75) Inventors: Zhiyi Zhang, Ottawa (CA); Gaozhi Xiao, Ottawa (CA); Guang Pan, Ottawa (CA); Pinqing Zhang, Ottawa (CA); Ming Zhou, Ottawa (CA)

Correspondence Address: FRIEDRICH KUEFFNER, 342 MADISON AVENUE, SUITE 1921, NEW YORK, NY, 10173, US

(73) Assignee: Zenastra Photonics Inc.

(21) Appl. No.: 09/850,709

(22) Filed: May 7, 2001

(30) Foreign Application Priority Data
May 29, 2000 (CA) 2,310,219

(51) Int. Cl. C03C 3/06

(52) U.S. Cl. 65/17.2; 65/901; 65/30.12; 359/642; 501/12

(57) ABSTRACT

Deuterium oxide, D₂O, also called heavy water, is used for the hydrolysis of silanes and metal compounds. The D₂O-hydrolyzed silanes polycondense much easier than H₂O-hydrolyzed silanes, resulting in a fast Si—O—Si network build up. The most important feature of using D₂O is that the final materials are 100% free of O—H and the residual O—D bond does not have an absorption peak in the wavelength range of 1.0 to 1.8 μm, which is crucial in reducing optical loss at the wavelengths of 1.3 and especially 1.55 μm. O—H free sol-gel materials with low optical loss have been developed based on this process. D₂O may be applied in all kinds of hydrolysis-processes, such as the sol-gel process of silanes and metal compounds, the synthesis of polysiloxane, and may be extended to other silica and metal-oxides deposition processes for example, flame hydrolysis deposition (FHD) whenever water is used or O—H bond involved. The concept of replacing O—H bond with O—D bond is applicable to any O—H bond containing materials used in optical based telecommunication.

### BACKGROUND OF THE INVENTION

1. Field of the Invention

This invention relates to the application of deuterium oxide, D₂O, in producing O—H free materials or chemicals for optical communication. The processes involved include, hydrolysis and polycondensation of silanes and metal compounds, such as the sol-gel process, and the optical deposition of silica and metal oxides. The resulting materials could be used as optical waveguides, adhesion promoters, coatings, adhesives and other materials where low optical loss is essential in the wavelength range of 1.55 μm or 1.3 μm.

2. Prior Art of the Invention

Low optical loss at working optical wavelengths, i.e. 1.3 and particularly 1.55 μn, is a key parameter for applying a material as light transmission medium in fiber optical communication. In silicon based materials, such as sol-gel based silica, O—H plays an undesirable role in building up high optical loss at the wavelengths of 1.3 and 1.55 μm which are the regular wavelengths used for optical communication, because O—H has a strong absorption peak in this wavelength region. Reducing O—H content in the materials is, therefore, extremely important in decreasing optical loss. However, it is very difficult to eliminate O—H in silica and metal oxidized materials. High temperature baking is the typical present way used to reduce O—H in processing the materials. For instance, high temperature baking at around 1200° C. is usually used to eliminate O—H when producing silica. This process does not experience technical problems in producing bulk components such as optical fibers, but it does cause some problems in coating deposition when the substrate is a different material. For example, the thermal expansion mismatch between a silicon substrate and the silica coating might introduce a significant stress in the silica coatings in a Flame Hydrolysis Deposition (FHD) process, and the capillary force-driven shrinkage can easily crack sol-gel deposited coatings at 600° C. or above. As for sol-gel based organic-inorganic hybrid materials, high temperature processes are completely unacceptable, because the organic part can only withstand a temperature below 300° C.

Recently, sol-gel based organic-inorganic hybrid materials were developed for fabricating optical waveguiding components. The materials contain two parts: an organic one with double bonds and an inorganic one with Si—O—Si network. They can be UV-patterned by using traditional photolithography technology and have good thermal stability. Various optical waveguide components, such as hybrid splitters, optical switches and waveguide gratings, were produced by using the hybrid materials. The materials are synthesized by hydrolyzing multi-functional methoxyl or ethoxyl silanes, followed by proper polycondensation.

U.S. Pat. No. 6,054,253 issued Apr. 25, 2000 to Fardad et al provided a method in producing waveguides by using methacryloxypropyl trimethoxysilane based on sol-gel process. High performance sol-gel waveguides were achieved with the technology. U.S. Pat. No. 5,973,176 issued Oct. 26, 1999 to Rocscher et al teaches us to use synthesize fluorinated silanes for sol-gel process in fabricating low optical loss waveguides.

However, polycondensation is never completed in the system, leaving a significant amount of residual O—H in the materials. Many approaches were used to reduce the O—H content, including, choosing proper silanes, proper sol-gel conditions (catalyst, concentration, solvent, temperature), and using a special monomer to react the O—H groups. It was reported that by eliminating O—H, the materials' optical loss can be reduced from several dB/cm to 0.5 dB/cm. Fundamentally, however, choosing proper silanes and reaction conditions cannot complete the condensation and thus eliminate the O—H in such a reactive system with multi-functional groups, because the condensation of multi-functional monomers can never be completed. This has been well recognized in polymer theory and experiment. By reacting residual O—H with a special monomer it is possible to eliminate all O—H, but the reaction may affect the network built up and thus deteriorate the material's thermal and mechanical properties.

An innovative prior art method to produce low O—H materials is to avoid the use of H₂O for hydrolysis. For instance, diphenysilandiols were used to react with methoxysilanes directly. However, residual methoxy groups are inevitable in the materials due to the problem mentioned above, i.e. multi-functional groups polycondensation can never be completed. Since C-H also has a strong absorption peak in the region of 1.3 to 1.55 μm, the residual methoxy itself, which contains three C—H bonds, could negate the benefit achieved by reducing the O—H content. As a result, real gain in reducing optical loss in the wavelength region by such approach is limited.

Indeed, it is a challenge to significantly reduce the O—H content without deteriorating material properties, or to eliminate O—H without introducing other chemical groups which have similar effects to O—H on building optical loss.

### SUMMARY OF THE INVENTION

The present invention provides an optical compound material for use in optical devices in the wavelength range between 1.0 and 1.8 micrometers, wherein substantially most O—H bonds are substituted by O-D bonds; H being protium and D being deuterium.

In a widely used compound material processes, is the sol-gel material a D₂O-hydrolyzed silane, or a D₂O-hydrolyzed metal compound.

The present invention also provides a method of producing optical compound materials substantially free from O—H bonds, comprises the steps of hydrolyzing and condensing of at least one of silanes and metal compounds using deuterium oxide (D₂O).

A sol-gel process for producing optical compound materials substantially free from O—H bonds, comprises the step of using deuterium oxide (D₂O) to provide compound materials containing Si—O—Si bonds M—O—M bonds, wherein M is a metal atom suitable for use in the sol-gel process, M is often one of the group of Aluminum (Al,), Zirconium (Zr), Titanium (Ti), Erbium (Er) and Germanium (Ge).

An optical compound material made by the process, will have low optical loss in the optical wavelength range between 1.0 and 1.8 micrometers.

A preferred application is a sol-gel process for maling optical gratings and optical index matching coatings providing low optical loss in the wavelength range between 1.0 and 1.8 micrometers.

Further, a process for producing optical compound materials substantially free from O—H bonds, comprises the step of using deuterium oxide (D₂O) in hydrolysis and condensation of silanes and metal compounds, for use as adhesives and surface treatments agents for promoting adhesion between silicon, silica, glass, metal oxide, or metal substrates with materials containing organic groups.

The process is applicable for producing optical compound materials wherein the material is one of the group of sol-gel materials, organic/inorganic hybrids, and polymer resins such as polysiloxane.

The method enhances hydrolysis and condensation of silanes and metal compounds in sol-gel processes and is characterized by the step of substituting deuterium oxide (D₂O) for protium oxide (H₂O).

The method of depositing silica and metal oxides on a substrate is characterized by use of deuterium oxide (D₂O) as hydrolysis agent.

The method of depositing silica and metal oxides on a substrate by flame hydrolysis deposition (FHD) is characterized by use of deuterium oxide (D₂O) as hydrolysis agent.

The method for reducing optical loss in the range between 1.0 and 1.8 micrometers in optical materials, wherein O—H bonds are replaced by O—D bonds, O being oxygen, H being protium and D being deuterium.

### BRIEF DESCRIPTION OF THE DRAWING

The preferred exemplary embodiments of the present invention will now be described in detail in connection with the annexed drawing figures, in which:

FIG. 1 shows the absorption of H₂O and D₂O in the near infrared region, measured by using Nicloet 470 FTIR/NIR spectrometer with transmission model and a 1 mm thick quart sealed liquid fell was used for the measurement; and

FIG. 2 shows the absorption of D₂O and H₂O based sol-gel materials in the near infrared region, measured by using Nicloet 470 FT spectrometer with transmission model and a sample thickness of 2 mm.

### DETAILED DESCRIPTION OF THE INVENTION

It is well known that any protium H in materials will increase optical loss in the range of 1.3 to 1.55 μm, a typical wavelength range for optical communication. The strategy to eliminate H is to replace H with fluorine F and deuterium D. This approach has received great success in replacing C—H bonds with C—F or C—D bonds. The reason is that the C—H bond's vibrational overtones occur near 1.3 and 1.55 μm, and the related energy is inversely related to the reduced mass. Due to the highly reduced mass of F and D, the fundamental bond vibrational overtones of C—F and C—D can be lowered, shifting the related absorption peak to longer wavelength range. Fluorinated and deuterated acrylate resins and fluorinated sol-gel materials are examples of successful systems. It should be noted, however, that while the replacement of C—H with C—F can reduce the optical loss at both 1.3 and 1.55 μm, the replacement of C—H with C—D can only reduce the loss at 1.3 μm because C-D has an absorption at 1.55 μm. C—D technology is definitely not suitable for the application at 1.55 μm. This excludes the application possibility of C—D technology because 1.55 μm is the wavelength used most in fiber optical communication.

The method of the present invention is to replace H₂O with D₂O for hydrolysis of silanes, followed by proper polycondensation. D and H are both isotopes of hydrogen. H is the most common isotope of hydrogen. It has a mass number of 1 and an atomic mass of 1.007822. Its nucleus is a proton. D, also called heavy hydrogen, has a mass number of 2 and an atomic mass of 2.0140. Its nucleus consists of a proton plus a neutron. D₂O, so-called heavy water, has a melting point of 3.79° C., boiling point of 101.4° C., and density of 1.107 g/cm³ at 25° C., in comparison to H₂O with 0°, 100° C., and 1.000 g/cm³, respectively. D₂O is not radioactive and is widely used as a moderator in nuclear reactors. The chemical properties of D₂O are generally considered same as H₂O because both D and H have one proton. The absorption behavior of O—D in comparison with O—H, is the reason for the present D₂O-based hydrolysis of silanes and other metal compounds, especially in sol-gel processes.

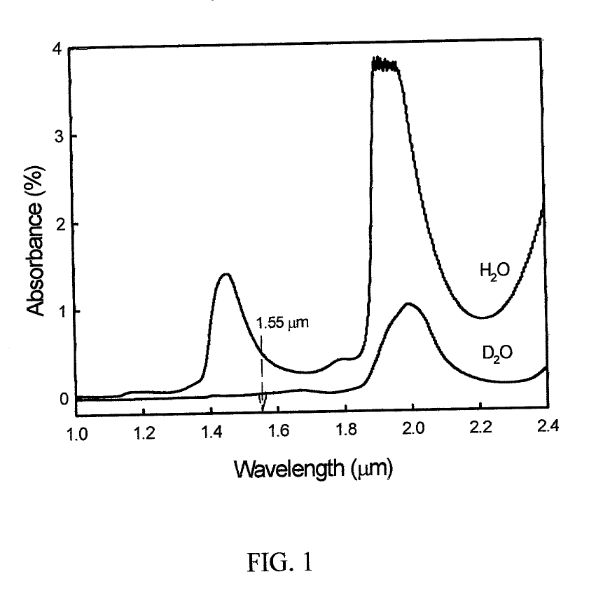

FIG. 1 shows the absorption spectrum of D₂O with H₂O in the near infrared region. The measurement was conducted by using Nicloet 470 FTIR/NIR spectrometer with transmission model. A 1 mm thick quart sealed liquid cell was used for the measurement. The first and second overtones of O—H are shown at 1.94 μm and 1.45 μm respectively with strong intensity. The absorption of H₂O at 1.55 μm is greatly enhanced especially by the second overtone, peak of O—H. On the other hand, the second overtone peak of O—D occurs at 1.98 μm with intensity lower than that of the second overtone peak of O—H at 1.45 μn, and the first overtone of O-D occurs at above 2.61 pm (not shown in the figure).

There is no absorption peak for O—D within the range of 1.0 to 1.8 μm. As a result, the absorption of D₂O at 1.55 μm is 1/10 of the absorption of H₂O at the same wavelength. The above result fits well in our theoretical calculation based on infrared theory.

Although the absorption peaks of O—D, in a material, such as polysiloxane resin, will not be the same with those in D₂O due to the changed chemical environment, the difference is generally quite small. It implies that for the same concentration of O—H and O—D in certain materials, the O—D containing system should have much lower chemical related absorption at 1.55 μm than O—H containing system. The D₂O based hydrolysis and condensation of silanes based on the present invention have been tested in the laboratory and can be expressed as:

Si—O—R+D₂O→Si—O—D (1)

Si—O—D+D—O—Si→Si—O—Si (2)

Si—O—D+RO—Si→Si—O—Si+RO—D (3)

Where R is an organic group, such as CH₃, C₂H₅, C₃H₇, . . . , etc.

The D₂O-based hydrolysis and condensation of metal compounds can be expressed as:

M—OR+D₂O→M—O—D (4)

M—O—D+D—O—M→M—O—M (5)

M—O—D+RO—M→M—O—M+RO—D (6)

Where R is the same as above, and M is a metal atom, such as Al, Ti, Zr, Er, Pb, . . . , etc.

As seen in the reaction equations, O—D is the only chemical residual in the materials. The obtained materials or chemicals are 100% O—H free.

The hydrolysis and condensation of silanes and metal compounds under D₂O, can be conducted under the same condition as those under H₂O. These reactions occur in acid or basic catalyzed environment. The difference between acid-catalyzed and basic catalyzed reaction is that acid is in favor of hydrolysis while basic is in favor of condensation. Chemicals, such as methanol, ethanol, isopropyanol, and acetone can be all used as the solvent for the reactions based on D₂O. Bulk reaction without any solvent can be also conducted in a controlled way. Reaction temperature can be kept at a wide range from room temperature to 80° C. The advantage of applying D₂O is that the technology based on H₂O, which was started a hundred year ago, can be copied and transferred to D₂O system with minor modification.

Very importantly, D₂O involved hydrolysis and condensation were found very easily in comparison with H₂O involved one. For instance, when H₂O and D₂O were respectively applied in the hydrolysis and condensation of methacryloxypropyl triethoxysilane in acid-catalyzed bulk system, the D₂O-based reaction is faster than H₂O-based one. The viscosity of the resulted resin from D₂O is 100% higher than that of the H₂O-resulted resin. Also, for a typical sol-gel process based on tetraethoxysilane in isopropyanol at acid condition, D₂O was found to be impossible to generate a transparent sol-gel solution because the condensation was too fast to produce and precipitate gel particles. On the other hand, transparent sol-gel solution was easily prepared under the identical condition with H₂O.

The easy hydrolysis and condensation is a real advantage for D₂O-based reactions. It means that less O—R will be left and more Si—O—Si will be formed in D₂O based system than H₂O's system, and the residual O—D in D₂O based system will be lower than the residual O—H in H₂O's system. In other words, even if O—D bond had the same absorption behavior as O—H in the region of 1 to 1.8 μn, D₂O based system will still have lower absorption, thus optical loss, than H₂O based system in the region. It can be expected that, in comparison with H₂O based system, D₂O based system should have even lower O—D bond-caused optical loss at 1.55 μm than that obtained from FIG. 1.

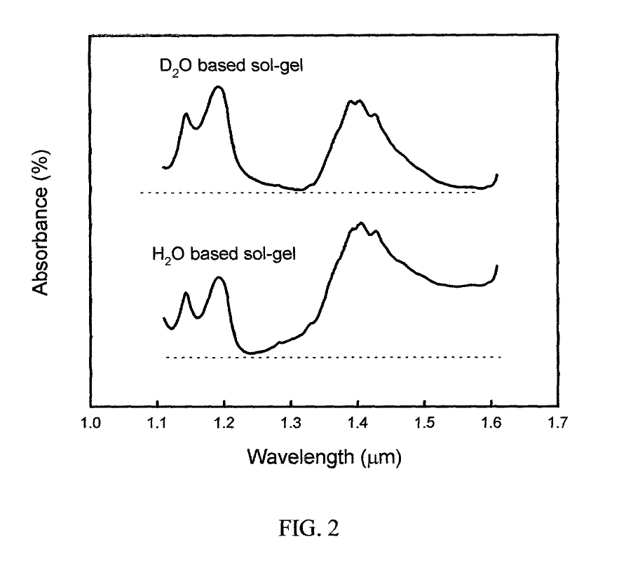

FIG. 2 shows the absorption of D₂O and H₂O based sol-gel materials in the near infrared region. The measurement was conducted by using Nicloet 470 FTIR/NIR spectrometer with transmission model and sample thickness was 2 m for both materials. The materials were synthesized from methacryloxypropyl trimethoxysilane and diphenyldiethoxysilane by sol-gel process, one with D₂O and another one with H₂O as hydrolysis agent. The peak at around 1.4 μm is due to C—H bond for D₂O based material, and C-H bond and O—H bond for H₂O based material. Consequently, the materials based on D₂O does not have an absorption shoulder at 1.55 μm, while the materials based on H₂O has a stronger O—H bond related shoulder at 1.55 μm. The waveguide propagation loss of D₂O based materials is 30% to 50% lower than that of H₂O based materials.

Since the hydrolysis and condensation can develop easily in D₂O-based reactions during the materials synthesis stage, less post reaction will be required for the materials processing stage for the system. The benefit is that lower baking temperature would be required for processing the materials reacted from D₂O and the achieved materials have less shrinkage during the processing, and have better thermal and mechanical properties than H₂O based materials. Also, it should be noted that the acid-catalyzed hydrolysis and condensation under D₂O is a problem for the hydrolysis and condensation of fluorinated silanes which are unstable under basic environment.

The D₂O technology has resulted in various O—H free materials in our lab. Sol-gel based silicon containing materials and metal containing materials, which can be used as waveguiding photonic device, surface treatment agent, coating, index matcher, and adhesives, are the representative examples. Such technology can be easily extended to other application for producing silica and metal oxides for optical communication. Manufacturing of waveguiding photonic devices by such as flame hydrolysis deposition (FHD), for instance, is the area where D₂O technology can be applied because H₂O is used in these processes and the elimination of residual O—H is big problem.

### EXAMPLE 1

25 g methacryloxypropyl trimethoxysilane was reacted with 4.4 g D₂O with acid HCL as catalyst at 20 room temperature. The mixture was opaque at beginning, and turned backed to transparent within 3 minutes. Reaction heat resulted temperature increase was detected to start at 2 minutes. The mixture was stirred for 16 hrs with aluminum foil covering the baker's top. Viscous resin was obtained from the reaction and the viscosity of the solution which contains D₂O and ethanol resulted from the reaction was measured at room temperature as 63.4 cp by using Brookfield viscometer. The solution was coated on silicon and glasses and baked at 110 to 130° C. for 24 hr. to produce flat, hard and transparent coatings. No O—H absorption was detected in the materials in the range of 1 to 1.8 μm by using Nicloet 470 FTIR/NIR spectrometer.

A parallel reaction with the replacement of 4.4 g D₂O with 4.2 g H₂O was also conducted. The reaction phenomenon was basically the same as the reaction with D₂O. The resulted resin after the same reaction time as above was measured as 31.6 cp of viscosity at room temperature.

### EXAMPLE 2

20 tetraethoxysilanes (TEOS) was reacted with 4.10 g D₂O with 4.8 g isopropanol in presence and HCL acid as catalyst. The mixture was opaque at the beginning, but turned backed to transparent within 3 minutes, and then turned into opaque. Reaction resulted temperature increase was detected to start within 2 minutes. After stirred for 1.5 hrs, opaque solution with fine suspended particles was obtained. These particles are visible when the solution was cast on glasses and the solvent was evaporated. Flat and hard coatings were obtained after the solution was filtered with 0.45 μm sized filter, and then coated by spinning coating, followed by baking at 110° C.

A parallel reaction with the replacement of 4.1 g D₂O with 3.9 g H₂O was also conducted. The reaction time was basically the same as the reaction with D₂O, however the solution only experienced transparent-to-opaque and opaque-to-transparent process and the final solution was transparent one with no suspended particles. Flat and hard coatings were obtained without filtering the solution

The particles generated from D₂O-based system during the reaction were silica gels. They were produced due to the fast condensation process. The solubility of silica gels in the solution is limited and the gel precipitate from the solution instantly when the gel particles reach certain size. Similar particles were reported in basic-catalyzed H₂O-based system because condensation under basic is very fast.

### EXAMPLE 3

25 g methacryloxypropyl triethoxysilane and 3.0 g D₂O was reacted under acid condition for 2 hr. and then mixed with the mixture of methacrylic acid and zirconium n-propoxide (18 g), and then 1.5 g D₂O for 2 hr. The resulted solution was viscous with a viscosity at room temperature as 142 cp when the measurement was done 48 hr after the reaction was completed. In the case that H₂O was used in the reaction, the resulted solution viscosity was measured as 52.6 cp under the same conditions. 2% mol photosensitive initiator (Irgacure) was added into the system to yield a free-flowing solution, which was passed through 0.2 μm filter.

Films were deposited on polished silicon by dip coating with the filtered solution and then prebaked at 100 for 30 min to stabilize the coating. They were then exposed to UV light through mask with desired opening to polymerize the macrylates component. After rinsing with a proper chemical and dried, desired waveguides were formed on the substrates. Channel waveguides with proper buffer and upper cladding, which were also based D₂O resulted materials, were prepared and tested. Their propagation loss at 1.5 μm is 30% less than that of the waveguides based on H₂O.

### EXAMPLE 4

15 g methacryloxypropyl triethoxysilane and 12 g diphenyldiethoxysilane were reacted with 5 g D₂O. A very viscous resin was obtained after the reaction. 2% mol photosensitive initiator (Irgacure) and a proper solvent was added into the system to yield a free-flowing solution. The solution was filtered through a 0.45 μm sized filter and deposited on silicon for preparing channel waveguides and casting cylinder/rectangular blocks with proper UV exposure and thermal treatment. Similar reaction based on H₂O was also conducted and the obtained material was used for comparison.

FIG. 2 shows the absorption of the materials in the near infrared range. The peak at around 1.4 μm is due to C—H bond for D₂O based materials, and C—H bond and O—H bond for H₂O based materials. Consequently, the materials based on D₂O does not have an absorption shoulder at 1.55 μm, while the materials based on H₂O has a stronger O—H bond related shoulder at 1.55 μm. The waveguide propagation loss of D₂O based materials is 30% to 50% lower than that of H₂O based materials.

### EXAMPLE 5

15 g phenyltriethoxysilane and 2.5 g diphenyldiethoxysilane were reacted with 5.8 g D2O under basic condition at 60° C. A very viscous resing was ontaied after the reaction was proceed for 7 hrs. After being cured at 130° C., the resin was measured to have a refractive index of 1.501 at 1.5 μm wavelength. The material was applied between two optical fibers and fiber to waveguide as low optical loss index matching materials.

### EXAMPLE 6

15 g methacryloxypropyl trimethoxysilane and 6.3 g diphenyldiethoxysilane were reacted with 6.3 g D2O under acid condition. After reacting for 7 hrs at 70° C., 70 ml acetone was added into the solution at room temperature, followed by adding 2 g tetraethoxysilane. 4 hrs later, 1 g of D2O was gradually added into the solution and the solution was kept stirring at room temperature for 24 hrs.

The obtained solution was used as surface promoter of silicon wager and silica for producing waveguides when using the materials as defined in EXAMPLE 4 as waveguide materials.

What is claimed is:

1. An optical compound material for use in optical devices in the wavelength range between 1.0 and 1.8 micrometers, wherein substantially most O—H bonds are substituted by O—D bonds; H being protium and D being deuterium.

2. The optical compound material as defined in claim 1, said compound material being a sol-gel material.

3. The optical compound material as defined in claim 1, said compound material being a D₂O-hydrolyzed silane.

4. The optical compound material as defined in claim 1, said compound material being a D₂O-hydrolyzed metal compound.

5. A method of producing optical compound materials substantially free from O—H bonds, comprising the steps of hydrolyzing and condensing of at least one of silanes and metal compounds using deuterium oxide (D₂O).

6. A sol-gel process for producing optical compound materials substantially free from O—H bonds, comprising the step of using deuterium oxide (D20) to provide compound materials containing Si—O—Si bonds M—O—M bonds, wherein M is a metal atom suitable for use in the sol-gel process.

7. The sol-gel process for producing optical compound materials as described in claim 6, wherein M is one of the group of Aluminum (Al,), Zirconium (Zr), Titanium (Ti), Erbium (Er) and Germanium (Ge).

8. An optical compound material made by the process defined in claim 6, having low optical loss in the optical wavelength range between 1.0 and 1.8 micrometers.

9. An optical compound material made by the process defined in claim 7, having low optical loss in the optical wavelength range between 1.0 and 1.8 micrometers.

10. The sol-gel process as defined in claim 6 for making optical coatings and optical index matching materials providing low optical loss in the wavelength range between 1.0 and 1.8 micrometers.

11. A process for producing optical compound materials substantially free from O—H bonds, comprising the step of using deuterium oxide (D₂O) in hydrolysis and condensation of silanes and metal compounds, for use as adhesives and surface treatments agents for promoting adhesion between silicon, silica, glass, metal oxide, or metal substrates with materials containing organic groups.

12. The process for producing optical compound materials as defined in claim 11, said materials being one of the group of sol-gel materials, organic/inorganic hybrids, and polymer resins such as polysiloxane.

13. A method of enhancing hydrolysis and condensation of silanes and metal compounds in sol-gel processes characterized by the step of substituting deuterium oxide (D₂O) for protium oxide (H₂O).

14. A method of depositing silica and metal oxides on a substrate, characterized by use of deuterium oxide (D₂O) as hydrolysis agent.

15. The method as defined in claim 14, being flame hydrolysis deposition (FHD).

16. A method for reducing optical loss in the range between 1.0 and 1.8 micrometers in optical materials, wherein O—H bonds replaced by O—D bonds, O being oxygen, H being protium and D being deuterium.
